(19) United States
(12) Patent Application Publication
(10) Pub. No.: US 2002/0121205 A1
(43) Pub. Date: Sep. 5, 2002

(54) Template stamp assembly with bubble level orientation

(76) Inventor: Paul Peterson, San Francisco, CA (US)

Correspondence Address: GARY CARY WARE & FREIDENRICH LLP, 1755 EMBARCADERO ROAD, PALO ALTO, CA, 94303-3340, US

(21) Appl. No.: 09/994,442

(22) Filed: Nov. 26, 2001

Related U.S. Application Data
(60) Provisional application No. 60/252,937, filed on Nov. 24, 2000.

(51) Int. Cl. B41K 1/56

(52) U.S. Cl. 101/405

(57) ABSTRACT

A stamp assembly for marking an object's surface with an outline of a hole to be formed therein, that includes a housing having a skirt portion defining an open ended pad cavity and a reference plane, a stamp pad slidably disposed in the housing and having a bottom surface with a raised indicia portion for applying ink in a pattern, a handle attached to the stamp pad, and a bubble level attached to the housing, the stamp pad or the handle for indicating a desired rotational orientation of the stamp pad. As the reference plane is placed against the object's surface in the desired orientation indicated by the bubble level, and pressure is applied to the handle, the raised indicia portion extends through the reference plane, makes contact with the object's surface, and forms an ink pattern on the object's surface in the shape of the hole outline.

This application claims the benefit of U.S. Provisional Application No. 60/252,937, filed Nov. 24, 2000, and entitled Template Stamp With Bubble Level Orientation.

### FIELD OF THE INVENTION

The present invention relates to template stamps, and more particularly to template stamps used in the construction industry for installing electrical junction boxes (e.g. outlet boxes).

### BACKGROUND OF THE INVENTION

Electrical junction boxes are metal boxes used to house electrical devices such as wall switches, wall plugs, thermostats, fire alarm strobes, etc. that are mounted in walls and ceilings. Typically, junction boxes are installed before the finished wall or ceiling material (e.g. wall board) is in place. However, in remodeling projects and some new construction projects, electrical junction boxes are installed in existing wall/ceiling covering.

The traditional method of installing an electrical junction box in existing wall/ceiling covering is to locate its intended position along the wall (or ceiling) using a tape measure, placing the box against the wall at that position, and tracing the outline of the box onto the wall using a pencil or pen. Then, a hole is cut into the wall along the traced outline. The box is then inserted through the hole and secured in place. To get the best fit both structurally and aesthetically, the hole should be just barely large enough in all directions to allow the insertion of the box therethrough.

This box installation process is not only time consuming, but takes great skill to repeatedly install junction boxes that are accurately placed in a level manner. One problem is that most electrical junction boxes are not perfectly rectangular, but rather have protruding tabs, screws and nuts that require the hole to have an irregular shape. Such boxes are hard to accurately trace on the wall given that the irregular protrusions are at various locations along the depth of the box. Further, it is difficult to get the traced outline to be accurately placed and level. Often times holes, and therefore the electrical boxes installed therein, are formed slightly askew and out of position, which is noticeable when other electrical boxes are installed near each other or the installed box is near a door jam or floor board. This difficulty in installing junction boxes is exacerbated when there is little working room around the target site (e.g. under sinks, between book cases, near wall or ceiling comers, etc.).

There is a need for a tool and method for accurately marking wall board to form holes that are accurately placed and level, with dimensions that match those of the electrical boxes being inserted therethrough.

### SUMMARY OF THE INVENTION

The present invention solves the aforementioned problems by providing a tool and method for marking junction box templates on wall board quickly and accurately.

In one aspect of the present invention, a stamp assembly for applying ink to a surface includes a housing having an open end that defines a reference plane, a stamp pad slidably disposed in the housing and having a bottom surface with a raised indicia portion extending therefrom for applying ink in a pattern of the indicia, a handle attached to the stamp pad so that pressure applied to the handle causes the stamp pad bottom surface to slide toward the reference plane, and a bubble level attached to one of the housing and the stamp pad and the handle for indicating a desired rotational orientation of the stamp pad. As the reference plane of the housing is placed against a surface in the desired orientation indicated by the bubble level, and pressure is applied to the handle, the stamp pad slides relative to the housing so that the raised indicia portion extends through the reference plane and makes contact with the surface.

In another aspect of the present invention, a stamp assembly for marking an object's surface with an outline of a hole to be formed therein includes a housing including a skirt portion that defines an open ended pad cavity wherein the open end of the pad cavity defines a reference plane, a stamp pad slidably disposed in the pad cavity and having a bottom surface with a raised indicia portion extending therefrom for applying ink in a pattern of the indicia wherein the indicia pattern is an outline of a hole to be formed in an object's surface, a handle slidably extending through an aperture in the housing and attached to the stamp pad wherein pressure applied to the handle causes the stamp pad bottom surface to slide toward the reference plane, and a bubble level attached to one of the housing and the stamp pad and the handle for indicating a desired rotational orientation of the stamp pad. As the reference plane of the skirt portion is placed against the object's surface in the desired orientation indicated by the bubble level, and pressure is applied to the handle, the stamp pad slides relative to the housing so that the raised indicia portion extends through the reference plane, makes contact with the object's surface, and forms an ink pattern on the object's surface in the shape of the hole outline.

In yet another aspect of the present invention, a method of making a hole in a wallboard for receiving an electrical junction box uses a stamp assembly that includes a housing having an open end that defines a reference plane, a stamp pad slidably disposed in the housing and having a bottom surface with a raised indicia portion extending therefrom for applying ink in an outline of a hole for receiving an electrical junction box, a handle attached to the stamp pad so that pressure applied to the handle causes the stamp pad bottom surface to slide toward the reference plane, and a bubble level attached to one of the housing and the stamp pad and the handle, for indicating a desired rotational orientation of the stamp pad. The method includes the steps of placing the reference plane of the housing open end against a wall board, moving the housing to a desired rotational orientation indicated by the bubble level, applying pressure to the handle so that the stamp pad raised indicia portion slides relative to the housing through the reference plane, makes contact with the wall board surface, and applies ink to the wall board in the form of the hole outline, and cutting a hole in the wallboard according to the hole outline formed thereon.

Other objects and features of the present invention will become apparent by a review of the specification, claims and appended figures.

### BRIEF DESCRIPTION OF THE DRAWINGS

FIG. 1 is a top view of the stamp assembly of the present invention.

FIG. 2 is a partially broken away side view of the stamp assembly of the present invention.

FIG. 3 is a bottom view of the stamp assembly of the present invention.

FIG. 4 is a top view of the stamp assembly of the present invention being used to locate and stamp the position of a hole for a junction box next to a door jam.

FIG. 5 is a top view of the ink pattern formed by the stamp assembly of the present invention.

FIG. 6 is a top view of the stamp assembly of the present invention, including story poles used to measure fix distances from the stamp assembly housing.

FIG. 7 is a top view of the stamp assembly of the present invention, with the bubble assembly attached to the stamp pad.

FIG. 8 is a top view of the stamp assembly of the present invention, with the bubble assembly attached to the handle.

### DETAILED DESCRIPTION OF THE PREFERRED EMBODIMENTS

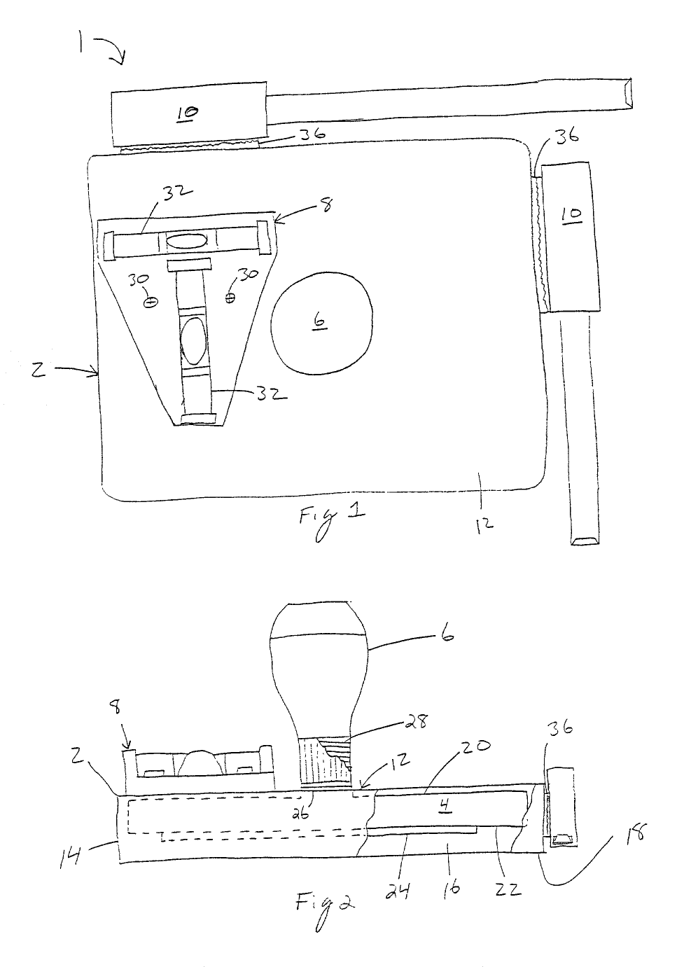

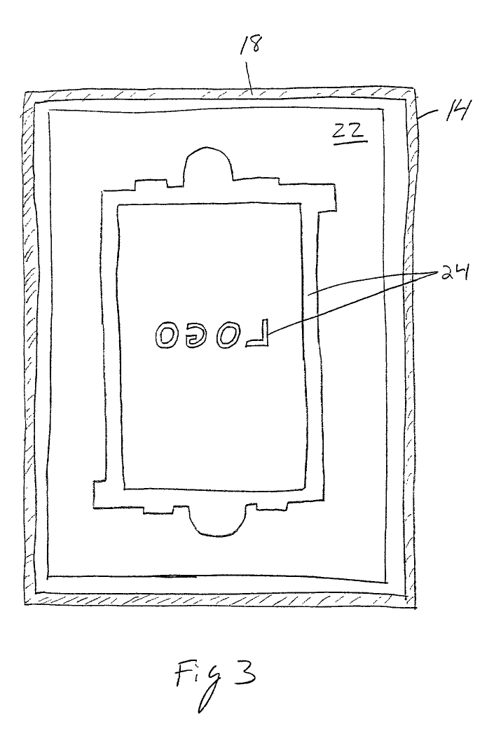

The present invention is a stamp assembly for conveniently and accurately marking template patterns on objects, such as electrical junction box outlines on wall boards, to make corresponding holes therein. Electrical junction boxes, such as a Bowers #52 commonly used in the art, are installed in the holes made in the wall boards (or other rigid surfaces such as cabinets, book shelves, ceiling material, etc). FIGS. 1-2 illustrate the stamp assembly 1 of the present invention, which includes a housing 2, a patterned stamp pad 4, a handle 6, a bubble level assembly 8, and a tape measure 10.

The housing includes a main wall 12 with a skirt portion 14 depending therefrom to form an open ended stamp cavity 16. The skirt portion 14 terminates to define a reference surface 18 (i.e. a reference plane) against which the object to be marked is placed.

The patterned stamp pad 4 is slidably disposed in the stamp cavity 16, and includes a top surface 20 facing the housing main wall 12 and a bottom surface 22 with a raised indicia portion 24 extending therefrom for applying ink in the pattern of the indicia. The handle 6 is attached to the top surface 20 of the stamp pad 4, and extends through an aperture 26 in the housing. Preferably, the stamp pad 4 is made of a pre-inked material such as vulcanized rubber that transfers ink to any object or surface coming in contact with the raised indicia 24.

The stamp pad/handle combination is spring loaded relative to the housing by a spring 28, which urges the stamp pad 4 away from the reference plane 18. When the reference plane 18 is placed against a fixed surface, and pressure is applied to the handle 6 toward the fixed surface, the stamp pad 4 is urged from an upper position (in which the patterned pad 4 is fully contained within the stamp cavity) to a lower position (in which the raised indicia portion 24 extends through the reference surface/plane 18 and against the fixed surface), where ink contained in the stamp pad 4 is applied to the fixed surface in the form of the indicia pattern. Such pre-inked stamps as described above are well known in the art, and are marketed by Royal Mark Corporation of Piscataway, N.J.

The stamp assembly of the present invention further includes the bubble level assembly 8 preferably attached to the housing 2 by a pair of screws 30. The bubble level assembly 8 includes a pair of bubble levels 32 that are both mounted parallel to the plane of the stamp pad 4, and perpendicular to each other. Bubble levels 32 are typically tubes filled with liquid and an air bubble that moves within the tube as it is rotated. When the tube is level, the bubble is located at the center of the tube. Since the bubble levels 32 are attached to the housing 2 and not the stamp pad 4, it is important that the stamp pad 4 not rotate relative to the housing 2. Each bubble level is oriented to be horizontal at a desired orientation of the indicia pattern. For many applications, two such orientations exist (vertical and horizontal orientations), and they are orthogonal to each other.

A pair of tape measures 34 are attached to orthogonal skirt portions 14 of housing 2. The tape measures are preferably removably mounted by hook and fabric fasteners 36, and positioned to measure the distance from the center of the indicia pattern.

The preferred indicia pattern used with the present invention is the outline of a hole for receiving a standard expandable junction box used to house wall switches, electrical outlets, thermostats, fire alarm strobes, etc. The outline pattern includes any necessary protrusions or extensions necessary for defining a hole through which the electrical junction box will pass, yet the pattern as a whole should be as small as possible for the best fit. FIG. 3 illustrates the bottom surface of the of the stamp pad 4, which includes a raised indicia pattern 24 matching the outer dimensions of a commonly available electrical junction box.

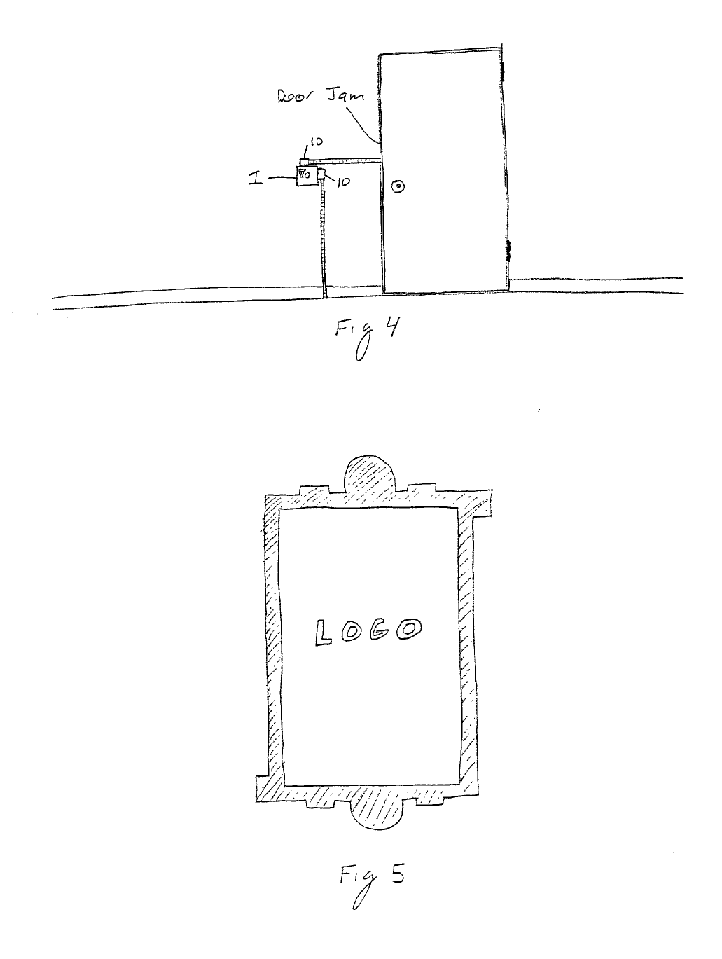

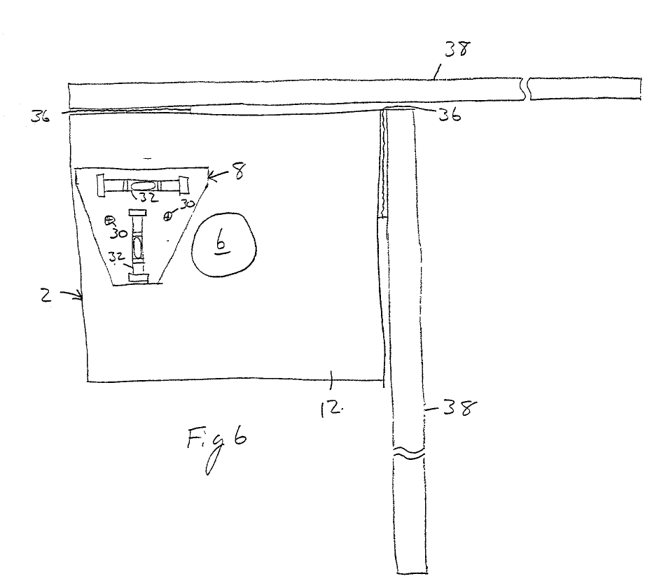

FIG. 4 illustrates the use of the stamp assembly 1 of the present invention, in which a wall switch junction box is to be installed next to a door jam. Once the reference surface 18 is placed against the wall, the horizontally oriented tape measure 10 is extended a predetermined distance to horizontally measure and place the stamp assembly 1 a desired distance from the door jam. The vertically oriented tape measure is extended a predetermined distance to vertically measure 10 and place the stamp assembly 1 a desired distance from the floor. The bubble level assembly 8 is then used to rotate the stamp assembly 1 so that the housing 2, and thus the stamp pad 4 therein, are level. Once the stamp assembly 1 is accurately placed and level, pressure is applied to the handle to force the stamp pad up against the wall, where the raised indicia 24 applies the ink pattern to the wall. The ink pattern is shown in FIG. 5, the outside of which preferably defines a template (outline) for cutting the hole into the wall so that the printed template is completely removed from the wall surface once the hole is formed. The center of the indicia pattern 24 can contain a logo that is not only viewable when the ink pattern is applied to the wall, but is also printed on the wall portion eventually removed as the hole is made (i.e. forming a business card or advertisement on the removed wall material). With the present invention, junction box templates can be repeatedly stamped onto wall boards with great accurately for forming holes having dimensions that just barely allow the junction boxes to pass therethrough. The present invention is especially ideal for construction and remodeling of tall buildings with hundreds or even thousands of junctions boxes.

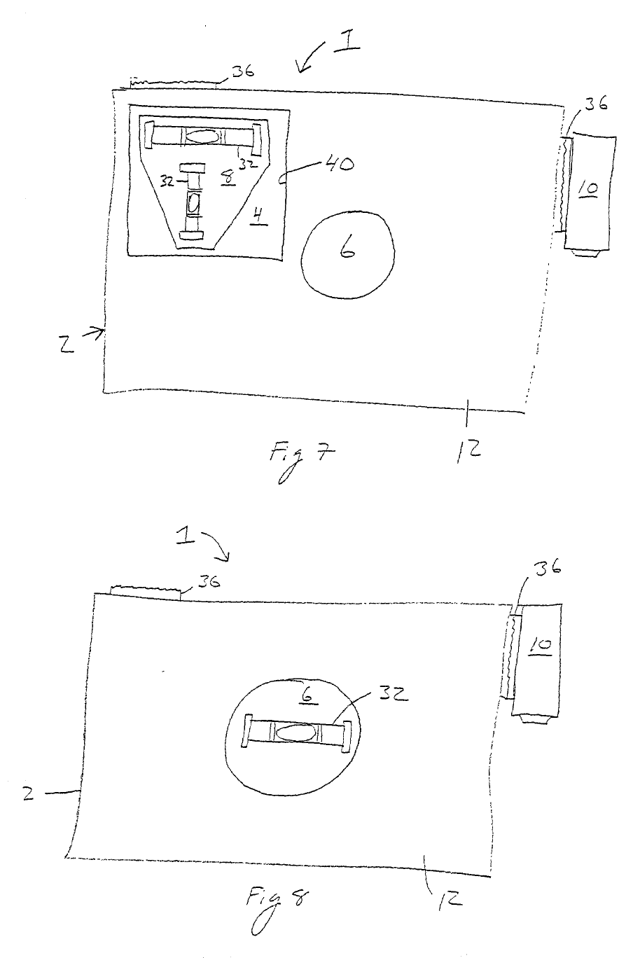

It is to be understood that the present invention is not limited to the embodiments described above and illustrated herein, but encompasses any and all variations falling within the scope of the appended claims. For example, while a pre-inked pad is shown, self inking or manually inked pads could alternately be used. Further, the skirt portion 14 of the housing 2 is shown as completely enclosing the stamp cavity 16. Yet, the skirt portion 14 could be notched or even cut back to form as few as three legs that define the reference surface/plane 18. Additionally, a single tape measure could be attached to the housing if only a single distance is critical for the placement of the stamp assembly. Alternately, one or more fixed length members 38 such as story poles or rulers can be removably attached to the stamp assembly, as shown in FIG. 6, to define fixed distances from the stamp assembly. While screws 30 and hook/fabric connectors 36 are shown connecting the bubble level assembly 8 and tape measures 10 or story poles 36 to the housing 2, any attachment mechanism known in the art (e.g. double stick tape, adhesive, magnets, injection molding, etc.) can alternately be used. Moreover, the bubble level assembly 8 need not necessarily be attached to the housing itself, but could rather be attached to the stamp pad (viewable through a transparent window or aperture 40 in the housing) as shown in FIG. 7, or be attached to the handle as shown in FIG. 8. Lastly, while the template shown is for cutting holes in walls for junction boxes, the present invention can be used to install junction boxes in any cuttable surface (cabinets, bookshelves, ceiling panels, etc), and the present invention includes other template patterns formed on the bottom surface 22 of the stamp pad 4 for other uses (anywhere that stamped patterns need accurate and level placement on objects).

What is claimed is:

1. A stamp assembly for applying ink to a surface, comprising:
a housing having an open end that defines a reference plane;
a stamp pad slidably disposed in the housing and having a bottom surface with a raised indicia portion extending therefrom for applying ink in a pattern of the indicia;
a handle attached to the stamp pad, wherein pressure applied to the handle causes the stamp pad bottom surface to slide toward the reference plane; and
a bubble level attached to one of the housing and the stamp pad and the handle, for indicating a desired rotational orientation of the stamp pad;
wherein as the reference plane of the housing is placed against a surface in the desired orientation indicated by the bubble level, and pressure is applied to the handle, the stamp pad slides relative to the housing so that the raised indicia portion extends through the reference plane and makes contact with the surface.

2. The stamp assembly of claim 1, further comprising:
a spring for urging the stamp pad away from the reference plane.

3. The stamp assembly of claim 1, wherein the handle movably extends through an aperture in the housing.

4. The stamp assembly of claim 1, further comprising:
a second bubble level attached to one of the housing and the stamp pad and the handle, for indicating an alternately desired rotational orientation of the stamp pad.

5. The stamp assembly of claim 4, wherein the bubble levels are oriented orthogonally from each other.

6. The stamp assembly of claim 1, further comprising:
a tape measure attached to the housing for measuring a distance from the stamp pad.

7. The stamp assembly of claim 1, further comprising:
a rigid member having a fixed length attached to the housing for measuring a distance from the stamp pad.

8. The stamp assembly of claim 1, wherein the pattern of the indicia is an outline of a hole to be formed in the surface for receiving an electrical junction box.

9. A stamp assembly for marking an object's surface with an outline of a hole to be formed therein, comprising:
a housing including a skirt portion that defines an open ended pad cavity, wherein the open end of the pad cavity defines a reference plane;
a stamp pad slidably disposed in the pad cavity and having a bottom surface with a raised indicia portion extending therefrom for applying ink in a pattern of the indicia, wherein the indicia pattern is an outline of a hole to be formed in an object's surface;
a handle slidably extending through an aperture in the housing and attached to the stamp pad, wherein pressure applied to the handle causes the stamp pad bottom surface to slide toward the reference plane; and
a bubble level attached to one of the housing and the stamp pad and the handle, for indicating a desired rotational orientation of the stamp pad;
wherein as the reference plane of the skirt portion is placed against the object's surface in the desired orientation indicated by the bubble level, and pressure is applied to the handle, the stamp pad slides relative to the housing so that the raised indicia portion extends through the reference plane, makes contact with the object's surface, and forms an ink pattern on the object's surface in the shape of the hole outline.

10. The stamp assembly of claim 9, wherein the hole outline is shaped to form a hole that receives an electrical junction box.

11. The stamp assembly of claim 10, further comprising:
a spring for urging the stamp pad away from the reference plane.

12. The stamp assembly of claim 10, wherein the ink pattern further includes a logo within the hole outline.

13. The stamp assembly of claim 10, further comprising:
a second bubble level attached to one of the housing and the stamp pad and the handle, for indicating an alternately desired rotational orientation of the stamp pad.

14. The stamp assembly of claim 13, wherein the bubble levels are oriented orthogonally from each other.

15. The stamp assembly of claim 10, further comprising:
a first tape measure attached to the housing for measuring a distance in a first direction from the stamp pad.

16. The stamp assembly of claim 15, wherein the first tape measure is removably attachable to multiple locations on the housing for measuring distances in different directions from the stamp pad.

17. The stamp assembly of claim 15, further comprising:
a second tape measure attached to the housing for measuring a distance in a second direction from the stamp pad that is orthogonal to the first direction.

18. The stamp assembly of claim 10, further comprising:
a rigid member having a fixed length attached to the housing for measuring a distance from the stamp pad.

19. A method of making a hole in a wallboard for receiving an electrical junction box using a stamp assembly that includes a housing having an open end that defines a reference plane, a stamp pad slidably disposed in the housing and having a bottom surface with a raised indicia portion extending therefrom for applying ink in an outline of a hole for receiving an electrical junction box, a handle attached to the stamp pad so that pressure applied to the handle causes the stamp pad bottom surface to slide toward the reference plane, and a bubble level attached to one of the housing and the stamp pad and the handle, for indicating a desired rotational orientation of the stamp pad, the method comprising the steps of:
placing the reference plane of the housing open end against a wall board;
moving the housing to a desired rotational orientation indicated by the bubble level;
applying pressure to the handle so that the stamp pad raised indicia portion slides relative to the housing through the reference plane, makes contact with the wall board surface, and applies ink to the wall board in the form of the hole outline; and
cutting a hole in the wallboard according to the hole outline formed thereon.

20. The method of claim 19, wherein the stamp assembly further includes a tape measure attached to the housing, and wherein the moving of the housing further includes moving the housing to a desired location by measuring a distance from a location along the wall board.
